(19) United States
(12) Patent Application Publication
(10) Pub. No.: US 2009/0123895 A1
(43) Pub. Date: May 14, 2009

(54) ENHANCED LEARNING ENVIRONMENTS WITH CREATIVE TECHNOLOGIES (ELECT) BILATERAL NEGOTIATION (BILAT) SYSTEM

(75) Inventors: Randall W. Hill, Altadena, CA (US); David Hendrie, Los Angeles, CA (US); Eric Forbell, Santa Monica, CA (US); Julia M. Kim, Los Angeles, CA (US)

Correspondence Address: MCDERMOTT WILL & EMERY LLP, 2049 CENTURY PARK EAST, 38th Floor, LOS ANGELES, CA, 90067-3208, US

(73) Assignee: UNIVERSITY OF SOUTHERN CALIFORNIA, Los Angeles, CA (US)

(21) Appl. No.: 12/261,299

(22) Filed: Oct. 30, 2008

Related U.S. Application Data
(60) Provisional application No. 60/983,849, filed on Oct. 30, 2007.

(51) Int. Cl. G09B 19/00; G09B 7/00

(52) U.S. Cl. 434/219; 434/323

(57) ABSTRACT

Methods, systems, and software are described of game-based simulations for students (such as soldiers) to practice conducting bilateral engagements in a cultural context. An embodiment provides students with the experience of preparing for and including familiarization with cultural context, gathering intelligence, conducting a meeting and negotiating when possible, and following up on agreements as appropriate. Embodiments enable the use of characters, scenario customization, as well as coaching, feedback and tutoring.

### CROSS-REFERENCE TO RELATED APPLICATION

This application claims the benefit of U.S. Provisional Application No. 60/983,849 filed 30 Oct. 2007 and entitled “Enhanced Learning Environments with Creative Technologies (ELECT) Bilateral Negotiation (BiLAT) System: A Virtual Practice Environment Focused on Preparing For and Conducting Bilateral Meetings in a Cultural Context,” attorney docket number 028080-0304; the entire contents of which are incorporated herein by reference.

### STATEMENT REGARDING FEDERALLY SPONSORED RESEARCH

This work was funded in part by United States Army Grant No. W911NF-04-D-0005. The Government has certain rights in the invention.

### BACKGROUND

Soldiers often encounter adversaries and neutral parties of foreign cultures when deployed, e.g., in a warfare theater. Among the difficulties of such situations is the problem of negotiating with people from differing cultures in a foreign cultural context. In addition to negotiations, soldiers can also encounter difficulties arising from the foreign cultural context when conducting interviews, business transactions, and the like.

Interactive, game-based techniques have previously been developed in attempts to reduce the difficulties of negotiating in a military setting with people of different cultures. Some of the difficulties with such prior art game-based training techniques have included a lack of appropriate instructional techniques, unrealistic or inappropriate training scenarios, and poor communication between instructors or subject matter experts (SMEs) and game developers.

What is desirable therefore are techniques that address such limitations noted for the prior art.

### SUMMARY

Embodiments of the present disclosure are directed to game-based simulations for students (e.g., soldiers) to practice conducting bilateral engagements (e.g., negotiations) in a cultural context.

An aspect/embodiment of the present disclosure is directed to a method of teaching the conducting of bilateral engagements in a cultural context. The method can include conducting preparation for a bilateral engagement. The preparation can include identifying a student's intended outcomes for the bilateral engagement and anticipating the objectives of the bilateral engagement meeting partner. The preparation can also include associating a time cost with each of a plurality of information resources assessed by the student. A rehearsal can be conducted of the bilateral engagement. Between the student and a virtual character, a simulation can be conducted of the bilateral engagement. The simulation can include one or more story-based scenarios. An attitude of the virtual character can be based in part on a level of trust that has been generated by earlier actions and conversations between the student and the virtual character. An after-action review can be conducted of the simulation. The student can be provided with a game-based graphical environment.

The graphical environment can include (i) an Experience Manager configured and arranged to support preparation for the bilateral engagement, (ii) a Dialogue Manager that is configured and arranged to generate spoken responses for the virtual character, (iii) a software module for automatically and dynamically generating non-verbal behavior of the virtual character based on a given utterance, and (iv) a social simulation module configured and arranged to determine negotiation decisions for business terms, and/or (v) an intelligent tutoring system including a coach, a reflective tutor, and/or an expert model. The method can also include providing the student with a user interface for interacting with the graphical environment.

A further aspect/embodiment of the present disclosure is directed to a system for teaching the conducting of bilateral engagements in a cultural context. The system can include a game-based graphical environment including an Experience Manager that is configured and arranged to support preparation for the bilateral engagement. A Dialogue Manager can be included that is configured and arranged to generate spoken responses for the virtual character. The system can also include a software module (or function) for automatically and dynamically generating non-verbal behavior of the virtual character based on a given utterance. A social simulation module can be included and configured and arranged to determine negotiation decisions for business terms. The system can also include an intelligent tutoring system including a coach, a reflective tutor, and/or an expert model. A user (student/soldier) can access the game-based graphical environment by way of an included personal computer and/or laptop or other device providing similar functionality.

A further embodiment of the present disclosure can include a development method including (1) analyzing a training domain, (2) developing a story board embodiment; (3) implementing a computer prototype; (4) further specifying and refining training objectives, conditions, and/or standards; and (5) developing training support material.

Embodiments of the present disclosure can be implemented in hardware, software, firmware, or any combinations of such, and over one or more networks and/or communications links.

Other features and advantages of the present disclosure will be understood upon reading and understanding the detailed description of exemplary embodiments, described herein, in conjunction with reference to the drawings.

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 depicts a block diagram representative of a method according to an embodiment of the present disclosure;

FIG. 2 depicts a block diagram representative of a system in accordance with an embodiment of the present disclosure; and

FIG. 2 depicts a block diagram representative of a development method in accordance with an embodiment of the present disclosure.

While certain embodiments/aspects are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION

Embodiments and aspects of the present disclosure provide game-based simulations for soldiers to practice conducting bilateral engagements in a cultural context. An embodiment of such a game-based system was developed and tested by the present inventors, and is referred to herein as “ELECT BiLAT”, standing for “Enhanced Learning Environments with Creative Technologies Bilateral Negotiation System.”

The simulations afforded can provide students/soldiers with the experience of preparing for a meeting including familiarization with the cultural context, gathering intelligence, conducting a meeting and negotiation when possible, and following up on meeting agreements as appropriate. As implemented in a computer-based situation, an ELECT BiLAT architecture can be based on a commercial game engine that is integrated with research technologies to enable the use of virtual human characters, scenario customization, as well as coaching, feedback and tutoring.

ELECT BiLAT can be used as a learning environment, an therefore pedagogy can be a central focus. A prototype embodiment of ELECT BiLAT followed a five-phase process: (1) analyze the training domain; (2) develop a story board embodiment; (3) implement a computer version of the training embodiment; (4) refine training objectives and link their conditions and standards to game activities; and (5) develop training support content for students, instructors, and training developers. The goal is an authorable game-based environment that uses the pedagogy of guided discovery for training soldiers in the conduct of bilateral engagements within a specific cultural context.

Techniques (e.g., systems/methods/software) according to embodiments of the present disclosure can include a software simulation consisting of (or implementing) a number of runtime components built upon existing software libraries. Such software libraries can include, but are not limited to, one or more of the following software programs: Unreal®Engine 2.5; HSQLDB; JSmooth wrappers; Active MQ4.1.1; Python 2.4; Numerical Python; Python Megawidgets; Xalan-J 2.7.0; Xerces-J 2.9.0; Chiba 1.2.0; JDOM™; Jave SE Runtime Environment (JRE) Version 5; Pthreads; and Xerces-C 2.7.

### 1. INTRODUCTION

The present disclosure describes, among other things, the development and components of the ELECT BiLAT training prototype, one of the first products of the Learning with Adaptive and Training (LAST) Army Technology Objective (ATO) program. Also described are underlying processes used during, and some of the initial lessons learned from, the development of the ELECT BiLAT training prototype. The purpose of the LAST is to develop tools and to prepare leaders and Soldiers conducting operations against an enemy in the Global War on Terrorism.

ELECT BiLAT was designed with a specific training objective in mind: to provide students an immersive and compelling training environment to practice their skills in conducting meetings and negotiations in a specific cultural context. Students assume the role of a U.S. Army officer who needs to conduct a series of bi-lateral engagements or meetings with local leaders to achieve the mission objectives. In one campaign the student is tasked with understanding why a U.S. built marketplace is not being used. The student must gather information on the social relationships among the characters in the scenario. The student must also establish his or her own relationships with these characters and be sensitive to the character's cultural conventions. Any misstep could set the negotiations back or end them completely. The student must also apply sound negotiation strategies such as finding win-win solutions and properly preparing prior to the meeting. The ELECT BiLAT social “simulation” was developed through a collaborative, multi-disciplinary approach and is part of the Enhanced Learning Environments with Creative Technologies (ELECT) suite of portable PC-based training programs designed to develop real-world skills. ELECT BiLAT was a part of the Learning with Adaptive Simulation and Training (LAST) Army Technology Objective (ATO). The project was a collaboration between the University of Southern California's Institute for Creative Technologies (ICT), U.S. Army Research Institute for the Behavioral and Social Sciences (ARI), U.S. Army Research Laboratory Human Research and Engineering Directorate (ARL-HRED) and U.S. Army Research Development, and Engineering Command's Simulation and Training Technology Center (RDECOM STTC). USC's Game Innovation Lab was involved in the game design as well as creating a compelling set of scenarios with realistic characters that would be appropriate for the training objectives identified.

To represent and model the social and cultural elements, the ELECT BiLAT infrastructure includes research technologies including a dialogue manager, SmartBody animation technology—from ICT's virtual human research project—, USC Information Science Institute's PsychSim social simulation system, as well as an intelligent coach and tutor to provide the student with run-time coaching and in-depth feedback during after action reviews. Authoring tools were developed to support the content workflow.

As previously stated, the ELECT BiLAT prototype is a game-based simulation that provides Soldiers a practice environment for conducting meetings and negotiations in a context. There are a number of aspects of this project that are worth reporting to the technology and training development communities.

In particular, ELECT BiLAT: (1) addresses a non-kinetic training domain that is relevant, e.g., to the Contemporary Operating Environment (COE), (2) game-play mechanics to provide a more immersive and interactive experience, (3) makes extensive of story-based scenarios, (4) virtual human and technologies to support social interaction, (5) incorporates intelligent tutoring to enhance the learning experience, (6) enables rapid scenario development and modification (e.g., the scenarios are authorable by the end-users), and (7) presents a pedagogically-oriented, live-phase approach throughout the development of the training embodiment.

Whereas there are examples of commercial games that have adapted to support military training objectives, ELECT BiLAT is a game-based training application built from the ground up with specific state training objectives in mind. The pedagogical design section describes an explicit framework for developing training objectives and refining them as the training application is built.

### 2. BILATERAL ENGAGEMENT

Embodiments of ELECT BiLAT can provide soldiers/students with an interactive, game-like simulation for practicing their skills in conducting meetings and negotiations with local leaders in a specific cultural context. For the ELECT BiLAT prototype developed by the present inventors, the training domain of bilateral meetings was chosen for its importance in current and future stability, security, transition, and reconstruction operations.

As used herein, the term “bilateral engagement” is used to describe the intentional activities of discussion, conference, and/or negotiation that take place between two parties to bring about agreement. In a military context, bilateral engagements occur at all levels of command, from squad leader to the general officer level; it is an activity that must be integrated with other operations in order to yield a successful campaign in a region. Another reason for the importance of mastering this skill set is that a successful bilateral engagement can save lives by defusing situations within a town or region where there exists the potential for agreement rather than violence. Lack of proficiency in this domain has the potential to cause second- and third-order effects with long-lasting negative consequences.

Emphasis can be placed on the preparation phases of a bilateral engagement and not only identifying one's own intended outcomes but also identifying and anticipating objectives of the meeting partner. This analytical process maps to two negotiation principles: (1) separate from the problem and (2) focus on interests, not positions. Successfully applying these principles requires extensive research to identify the problem and the interests of the partners.

Following the initial analysis of the objectives and interests of both parties, the next phase of methodology can be referred to as “develop intended outcome strategy” which maps to a third negotiation principle—invent options for mutual gain. It is during this phase that the planner can identify a bottom line that serves as an acceptable alternative outcome to intended outcome. While this process does not guarantee that the planner will necessarily identify an option that maximizes mutual gain, higher headquarters can suggest win-win solutions during this phase through coaching and feedback.

After planning is complete, the meeting is conducted, with particular attention paid to time management and sequencing. While the planning process is a necessary condition for success, the ability to interact at a personal level is also crucial. Again, good preparation can help, especially if it includes gaining an understanding of the cultural background of the meeting partner. Understanding the culture (which can be defined as a shared set of traditions, belief systems, and behaviors) such as communication styles, perception (both ways) and how respect is shown (or not) profoundly influences the outcome of a bilateral engagement; these same factors can be crucial in principled negotiation.

Finally, following the meeting, it may be critical (or preferred) that the leader follow through on promises made, identify outstanding issues, and plan next steps. In many cases, the knowledge gained from one bilateral engagement may have a direct bearing on who the next meeting partner should be and what issues are raised in subsequent meetings.

### 3. GAME-ORIENTED DESIGN

The present inventors and other colleagues devised training objectives for the ELECT-BiLAT prototype to address. The game design team proceeded to create a story board embodiment that allowed them to iteratively test game play mechanics before committing to the expensive step of writing computer code and creating artwork. An embodiment was play-tested internally and with subject matter experts (“SMEs”). In each phase of testing the feedback was factored into the design of another version of the system/prototype.

An embodiment of the game was designed to focus the student on performing tasks directly related to the training objectives identified during the task analysis. The design supported the concept of a multi-phase process for bilateral engagement: meeting preparation, rehearsal, conducting the meeting, and after action review. The game play experience depended on the attention to details in the process (e.g., the modeling of constraints like time, resources and trust).

For example, during the preparation phase, each information resource accessed by the student can be associated with a time cost associated. The game does not, however, necessarily have to model actions in real-time. Rather, time can be deducted from an in-game clock as a way to represent how long it might have taken in real world to track down the information and process it. During the meeting phase, the attitude of the meeting partner can be (and preferably is) affected in part by the level of trust that has been generated by earlier actions and things said. The trust variable is one of a number of variables that affect the game play, but it is the only one exposed to the student. It is a simplistic representation of a complex behavior but can serve as a way of reminding the student of the importance of building trust with the meeting/engagement partner.

### 4. STORY-BASED SCENARIOS

As mentioned above, a component of the ELECT BiLAT prototype includes the use of story-based scenarios. A training experience in ELECT BiLAT does not necessarily have to end with a single bilateral meeting, rather, can include a series of meetings that accomplish a broader set of mission objectives. This aspect of the game design reinforces the notion that leaders (e.g., Army, Marines, etc.) are dealing with complex social networks that interconnect and affect one another in sometimes surprising ways.

The scenarios built into the ELECT BiLAT prototype were loosely based on open-source stories about encountered in different locales around the world. The writers developed fictional characters with varying backgrounds and attitudes that require the player to understand each individual, their interests and issues, and their cultural background as it relates to the others in the social networks of the scenario.

There is a qualitative difference between a story-based scenario and the event-based scenarios that are typically used to drive military simulations. Stories have rich characters with the power to engage the user during interactions. Good stories have interesting plots, with dilemmas, suspense, and unexpected twists. A well designed story contains many links among characters and events so it is not just a physics-based cause-and-effect experience, rather, “social physics” are at play, which are much unpredictable. A well-crafted story-based scenario allows the student to have a social experience that is not achievable in an event-driven simulator.

### 5. TECHNOLOGIES

The ELECT BiLAT prototype was structured around the major phases of a bilateral engagement: preparation, rehearsal, meeting and after-action review. While each phase requires a specific functionality, they all share the need for visualization and a user interface. ICT's Integrating Architecture (IA) (van Lent, et al., 2004)—a communications and software platform supporting research component integration—can provide the graphical environment via an embedded Unreal 3D game engine commercially available through Epic Games. To support the needs of the game play and scenario content, as well as the goal of authorability, the system architecture underneath the platform was designed as a service-oriented, heterogeneous and network-based architecture consisting of discrete agents providing the following functions: graphical user interface, dialogue management, social simulation, experience management, character animation, online coaching and reflective tutoring.

The Experience Manager (EM) supports the preparation phase whereby the trainee conducts research and rehearsals prior to engaging with the selected meeting partner. The EM manages character availability, the research available on each, and the set of game objectives requiring completion to progress in the scenario. It is also responsible for initializing the game environment prior to the meeting starting. The preparation phase is very information-intensive, and required several usability studies in order to finalize an accessible interface. Preparation was also authoring-intensive requiring scenario details that could be discovered and then linked to executable actions in the meeting to follow.

Meetings in ELECT BiLAT are enabled through a simulation that can be supported by several components. A Dialogue Manager (DM) can handle turn-by-turn conversation for the virtual character and passes utterances to Smartbody for non-verbal behavior generation. Smartbody sends these animation and speech timing signals Io IA in order to render the character's onscreen performance. Throughout the meeting, the user is assisted by the coach based on relevant meeting traffic. The coach relics on the tutor system's knowledge database that is populated with pedagogical meta-information for the entire meeting. See, e.g., Thiebaux, M., et al., “SmartBody: Behavior Realization for Embodied Conversational Agents,” Proceedings of Autonomous Agents and Multi-Agent Systems (AAMAS), 2008 and Marcelo Kallmann and Stacy Marsella, “Hierarchical Motion Controllers for Real-Time Autonomous Virtual Humans”, in 5th International Conference on Interactive Virtual Agents, Kos, Greece, 2005; the contents of all of which documents are incorporated herein by reference in their entireties. See also Jina Lee and Stacy Marsella, “Nonverbal Behaviour Generator for Embodied Conversational Agents,” in 6th International Conference on Intelligent Virtual Agents, Marina del Rey, Calif., 2006, the entire contents of which are incorporated herein by reference.

Finally, the Psychsim social simulation determines negotiation decisions during the sub-phase of the meeting where business terms are being offered and requested. See, e.g., Stacy. C. Marsell, et al., “PsychSim: Agent-based Modeling of Social Interactions and Influence”, Proc. of the 6th International Conf. on Cognitive Modeling, Carnegie Mellon University (June 2004); the entire contents of which are incorporated herein by reference. See also the following: U.S. Patent Publication No. 20070206017, published 6 Sep. 2007 and entitled “Mapping Attitudes to Movements Based on Cultural Norms”; U.S. Patent Publication No. 20070082324, published 12 Apr. 2007 and entitled “Assessing Progress in Mastering Social Skills in Multiple Categories”; and U.S. Patent Publication No. 20070015121 published 18 Jan. 2007 and entitled “Interactive Foreign Language Teaching”; the entire contents of all of which applications are incorporated herein by reference.

Authoring scenario details for the meeting consisted of building high-level meeting actions (e.g., flatter host) and specifying the possible effects on the meeting partner. Dialogue utterances were written and then mapped in the system to an effect on the meeting partner. They could also be mapped to spontaneous conversational interjections triggered by defined pre-conditions (e.g., the meeting partner offering tea when pleased with how the meeting is progressing).

All meeting actions for the ELECT BiLAT prototype were linked to training objectives that are tracked by the coach and tutor system. Dialogue utterances are then processed through a non-verbal generation and speech workflow to cache the Smartbody animation data needed. Finally, the more strategic negotiation actions are defined and parameterized with respect to meeting partner goals for consideration by the PsychSim system.

To complete the game cycle, an after-action review follows all meeting engagements and is hosted by the reflective tutor. During a simulated meeting, the tutor dynamically builds an agenda to review with the trainee. The post-meeting walkthrough consists of a Socratic discussion of both positive and negative meeting events. Visualization was supported by the Dialogue Manager's utterance history and a “VCR” playback via Smartbody in a virtual video display. At the conclusion of the analysis session and the meeting cycle, the trainee returns to the objectives status screen in order to consider what to do next based upon what s/he has learned.

The software infrastructure supports the overall training objectives of the game as well as the scenario content needed to provide an immersive student experience. Some of those components were the result of the transition of research technologies, many of which were never previously available for game environments.

The SmartBody project (Lee & Marsella, 2006; Kallmann & Marsella, 2005) is part of the ICT's virtual human project (Swartout et al, 2006). SmartBody was designed to employ a range of different animation techniques. Most significantly, it supports an approach to procedurally generated animation that generates behavior dynamically and automatically, given an utterance. The integration of this technology makes it possible to more rapidly generate and modify scenarios beyond what is currently contained within the system.

PsychSim (developed by Marsella & Pynadath, 2004; Pynadath & Marsella, 2005) is an artificial intelligence (AI) framework for implementing social simulation and provides a great deal of power to model the impact that group membership has on the attitudes of a meeting partner, and vice versa. To facilitate the authoring of PsychSim models, a tool was developed that takes an author-provided high-level specification of the negotiation participants and automatically translates that specification into PsychSim models. PsychSim also provides explanation facilities for its behavior that will eventually be coordinated with the explanation and dialogue capabilities of our Expandable AI (XAI) system.

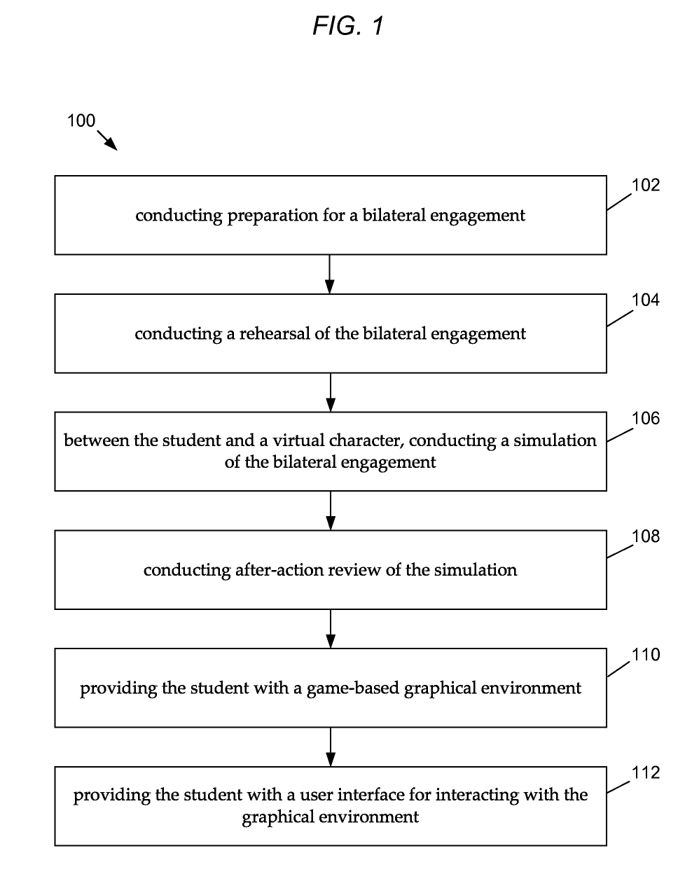

FIG. 1 depicts a method 100 of teaching conducting bilateral engagement in a cultural context, in accordance with a exemplary embodiments of the present disclosure. The method 100 can include conducting preparation 102 for a bilateral engagement. The preparation can include identifying a student's intended outcomes for the bilateral engagement and anticipating the objectives of the bilateral engagement meeting partner. The preparation can also include associating a time cost with each of a plurality of information resources assessed by the student. A rehearsal 104 can be conducted of the bilateral engagement. Between the student and a virtual character, a simulation 106 can be conducted of the bilateral engagement. The simulation can include one or more story-based scenarios. An attitude of the virtual character can be based in part on a level of trust that has been generated by earlier actions and conversations between the student and the virtual character. An after-action review can be conducted of the simulation.

Continuing with the description of FIG. 1, the student can be provided with a game-based graphical environment 108. The graphical environment can include (i) an Experience Manager configured and arranged to support preparation for the bilateral engagement, (ii) a Dialogue Manager that is configured and arranged to generate spoken responses for the virtual character, (iii) a software module for automatically and dynamically generating non-verbal behavior of the virtual character based on a given utterance, and (iv) a social simulation module configured and arranged to determine negotiation decisions for business terms, and/or (v) an intelligent tutoring system including a coach, a reflective tutor, and/or an expert model. The method 100 can also include providing the student with a user interface 110 for interacting with the graphical environment.

One skilled in the art will appreciate that method 100 (as well as others according to the present disclosure) can be implemented as computer-readable instructions resident in a computer-readable medium and/or signals.

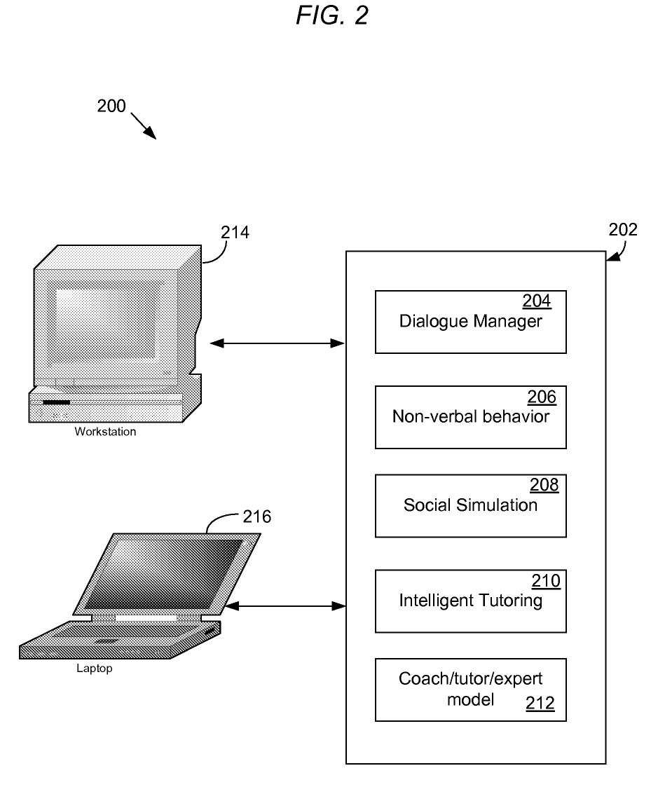

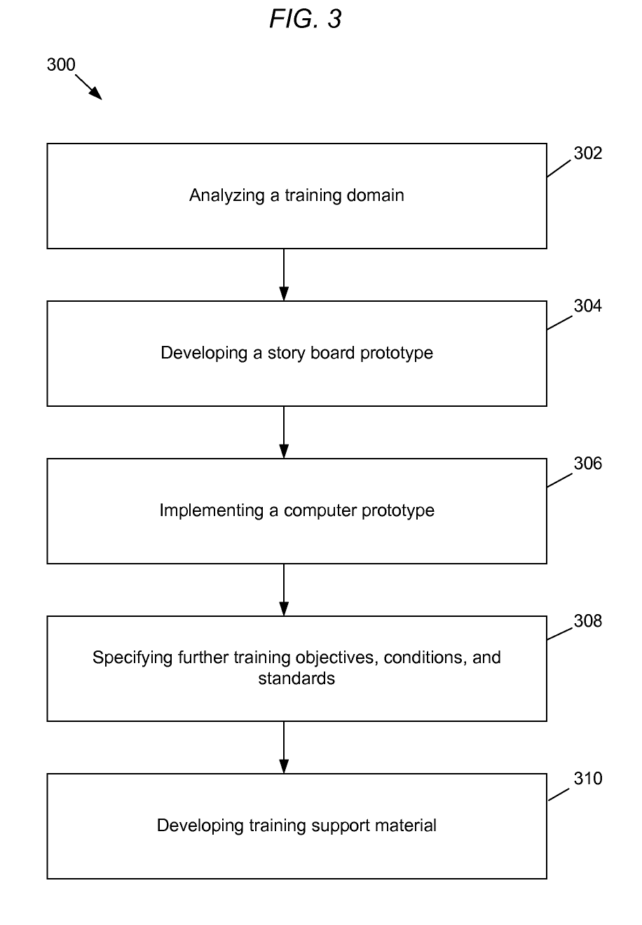

FIG. 2 depicts a system in accordance with an exemplary embodiment of the present disclosure. System 200 includes a game-based graphical environment 202 including an Experience Manager 202 configured and arranged to support preparation for the bilateral engagement. A Dialogue Manager 204 can be included that is configured and arranged to generate spoken responses for the virtual character. The system 200 can also include a software module (or function) 206 for automatically and dynamically generating non-verbal behavior of the virtual character based on a given utterance. A social simulation module 208 (e.g., PsychSim or the like) can be included and configured and arranged to determine negotiation decisions for business terms. System 200 can also include an intelligent tutoring system 210 including a coach, a reflective tutor, and/or an expert model 212.

Continuing with the description of system 200, a user (student/soldier) can access the game-based graphical environment 202 by way of a personal computer 214 and/or laptop 216 or other device providing similar functionality. One skilled in the art will appreciate that the graphical user environment 202 can be provided by software resident within a computer accessible to the user (e.g., personal computer 214 and/or laptop 216) or provided to such a computer by way of one or more communication links, networks, and/or external drives/memory devices.

### 6. COACHING AND REFLECTIVE TUTORING

For learning to be effective it should be guided (Kirschner, et. al., 2006). To provide guidance in ELECT BiLAT, an intelligent tutoring system (ITS) is included as a key component of the system, as was described previously for FIG. 2. Two kinds of ITS technology were implemented for the ELECT BiLAT prototype: a coach and a reflective tutor. The coach can be used during meetings to provide feedback and hints, while the reflective tutor can work with the coach to guide after-action reviews (AARs).

The coach can run (operate) in the background watching/monitoring actions taken by the player during meetings. Each action can be assessed as correct, incorrect, or mixed. To make this determination, the coach can consult an expert model (which can also be part of the ITS architecture) that can look up the learning objective(s) associated with the action and whether or not that action moved the negotiation partner closer to an ideal state (e.g., when trying to build trust, did the action actually improve trust?). The coach also decides whether or not to give explicit feedback after each action by consulting pre-configured settings. For example, an instructor can adjust the coach to give only negative feedback after errors. Or, the coach can be set to give positive feedback on a schedule (e.g., every second correct action), or in some combination with negative feedback. Finally, the coach maintains a rudimentary model of the learner based on learning objectives, and can give targeted feedback when certain learning objectives are active.

Since there may be little time for extended periods of discussion during a meeting, effort was taken to keep coaching utterances short and to the point. Using the coach's assessment, the reflective tutor can generate an agenda of topics to discuss during the AAR. The tutor can then use a cognitive model that includes a variety of tutoring tactics to address these topics. With such tactics as direct feedback, conceptual questioning, “what else” questions (asking about alternative courses of action), and XAI investigations (allowing students to ask virtual humans in the game to explain their actions), the reflective tutor is able to go beyond simple mission statistics and discuss the conceptual issues of the domain.

### 7. PEDAGOGICALLY ORIENTED DEVELOPMENT PROCESS

The development of ELECT BiLAT prototype started with a critical assumption: the game environment is not a vehicle by which learning is delivered, but rather it provides a practice environment to augment and internalize lessons learned. Prior to interacting with the ELECT BiLAT training embodiment the student should receive instruction on how to conduct a meeting engagement, how to negotiate, and how the particular culture being studied will influence the conduct of meetings and negotiations.

One lesson the present inventors learned is that there can be at least five phases in the process of developing an immersive training system that is pedagogically-structured and designed so that new scenarios can be authored. FIG. 3 depicts an embodiment of a development method 300 based on the five phases, in accordance with the present disclosure. Development process/method 300 can include the following: (1) analyze the training domain, as described at 302; (2) develop a story board embodiment, as described at 304; (3) implement a computer embodiment, as described at 306; (4) further specify and refine training objectives, conditions, and/or standards, as described at 308; and (5) develop training support material, as described at 310. While this process 300 was used specifically for the ELECT-BiLAT training game, it could also be used by other training system developers who are interested in producing pedagogically structured, immersive training environments.

1. Analyzing the Training Domain 302. The first stage in the rapid development of this training application began with examining the Contemporary Operating Environment (COE) to determine the focus of training for the application. The next step was to organize the knowledge and skill domain of what would be trained. However, there was no prior official delineation of this training domain, which clearly represents a “wicked problem,” with better or worse rather than right or wrong solutions (Rittel & Weber, 1973). Therefore, this required the development of training objectives based on a task analysis of the domain.

Project team members interviewed subject matter experts (SMEs) and reviewed available literature in the training domain as part of the cognitive task analysis process (DuBois & Shalin, 2000; Hackos & Redish, 1998). This process of identifying and organizing training domain content started with discussions and interviews in conjunction with the initial Army customer, but also included other interviews at various military facilities with related domain experience. SMEs were asked about appropriate and inappropriate actions, the conditional variables that influence specific courses of actions, and how they currently instruct trainees. SME interview data was combined with available documentation specifying the necessary phases, tasks and key personnel. The documentation used as primary references for this information included field manuals (Air Land Sea Application Center, 2004; Department of Army 1993, 1994), articles written by deployed military personnel and leaders (Heidecker & Sowards., 2004; Karabaich, 2005), and research reports (Meliza, 1996; Morrison & Meliza, 1999).

These data were then coalesced into training objectives that indicate appropriate and inappropriate tasks, based on specific conditions, and the standard to which these tasks should be demonstrated; a format familiar to Army instructors (Department of the Army, 2003). Each training objective consisted of three sections: the general description of the training objective, the conditions where the training objective was relevant, and the standards indicating the actions that would demonstrate adherence to the training objective.

One training objective identified was the use of a win/win strategy during negotiation (described in section 2, infra). During the training domain analysis process, LTC Wunderle and three other Army SMEs emphasized the importance of win/win. To illustrate the role pedagogy played throughout the development process, the impact of this training objective on the development of the training tool will be described in the subsequent steps.

2. Develop Story Board Embodiment 304. As described in section 3, the game designers developed a paper and pencil embodiment, or story board. This embodiment game design was linked to the results of the analysis phase. An instructional planning document based on the task analysis and the training objectives was developed to delineate the training domain information and outline the requirements of the game. Pedagogical controls were also drafted (e.g., how feedback could be structured), and implemented in the paper board-game.

The embodiment was demonstrated for instructors that would ultimately use the training system and additional Army personnel. The feedback gained from these demonstrations was used to guide modifications to the training game before subsequent demonstrations in an iterative development process. The use of a paper embodiment allowed for rapid modifications to the embodiment without incurring expensive and time consuming computer programming resources. It was also during this phase that in-game content started to be created based on SME vignettes. The content was tied to the training objectives and validated by SMEs. The training objectives were used as an information source for game content (characters, stories, etc.) and the training objectives served as an overarching framework.

For example, the win/win strategy for negotiation was integrated into two key game design elements identified in this embodiment. First, the preparation phase of the game required the player to identify the negotiation partner's desired outcomes promoting a win/win framework by promoting a student's understanding of a negotiation partners needs or wants (e.g., a police captain needs helmets and flashlights for his officers).

The second aspect of the game reinforcing this training objective was identified in the actual negotiation phase of the game. If the student learned about the need for helmets and flashlights, s/he was expected to try to acquire those resources, then offer them during the negotiation. Without these to offer, the student would not achieve a win/win outcome and the chances of successfully negotiating would be reduced.

3. Implement Computer Embodiment 306. Using the paper embodiment as a development plan, the transition to a computer embodiment was initiated. This included design of the user interface, implementation of the game mechanics, implementation of the authoring environment, and encoding of the initial scenario content. As this occurred, further SME feedback was incorporated to validate game mechanics and content.

When working versions of the system were available, playability testing was conducted with training instructors and other Army personnel. Playability testing provided an important iterative role in the development process. By putting pre-alpha game versions in front of end-users, feedback could be collected about game mechanics, in-game content, and realism of Army tactics, techniques, and procedures (TTPs) modeled in the computer environment.

An authoring tool was developed along with the initial embodiment. It promotes a pedagogical approach to content development by situating training objectives as the fundamental component of a new scenario, requiring that they be created first. As game content is developed, the learning objectives are linked with relevant training objectives so that the coach can perform assessments and the reflective tutor can conduct AARs. The win/win training objective is connected to game actions such as telling your partner that the “U.S. wants to cooperate and work with the Iraqi police” (an example of the subtask of developing relationships).

4. Refine Training Objectives, Conditions and Standards 308. As described above, the training objectives and their related sub-tasks were refined, and linked to game actions as a means of “scoring” and continuous assessment. The ITS in the game monitors play on a turn-by-turn basis and keeps a record of the learner's successes and failures. A second benefit of explicitly linking training objectives to game content is that it provides an indirect confirmation of the game content. That is, if it is found that certain game actions do not seem to support any training objective, or that some training objectives are “orphaned”, then it is clear that revision is needed.

This organization of training domain content allowed for the identification of commonalties among tasks that were considered appropriate, tasks that were considered inappropriate, and the conditions that influenced the appropriateness of these tasks. This structuring included both what should be done and what should be avoided, which allowed the ITS to identify both correct and incorrect responses and the conditions that influence the appropriateness of actions.

For example, if the student selects the action to tell his/her partner the U.S. will cooperate with local police at the appropriate time—during a business phase—the coach will recognize this as a positive action, and if the positive feedback is “turned on,” deliver the message “This action builds trust and rapport,” which reinforces the training objective of creating win-win situations. If the student needs a hint, the message would be “How can you collaboratively resolve this conflict?” If the action is taken during a “social” period, it will be considered an error. A different training objective in the game is to follow the social lead of the host—if the player attempts to talk about business before being cued to do so, there are similar (negative) feedback messages for that case. The reflective tutor can devote more time to discussion since it runs after the meeting when it won't break the flow, so its utterances include deeper explanations for why actions are good or bad and may discuss possible alternative courses of action.

5. Develop Training Support Material 310. Lastly, a set of learning material and instructions for training developers, instructors and students was produced to allow for turn-key employment of the learning application, either as part of an existing Program of Instruction (POI) or as a stand alone learning module.

This training support material can include introductory information on the training domain so that trainees can learn the information that they will practice while using the ELECT-BiLAT training system. Also included in the support material are directions for instructors on how to use the game interface, work through the phases of the game and ideas on how to use the game to promote discussion and learning in a class. Much like the reflective tutor, these training materials help tie the training objectives to the game content. In the case of the win/win example, the materials provide background and examples to show how an instructor might discuss successful negotiation tactics in the context of the game.

### 8. CONCLUSION

In the past, some of the difficulties with game-based training included a lack of appropriate instructional techniques, unrealistic or inappropriate training scenarios, and poor communication between instructors/SMEs and game developers (Belanich, Mullin, & Dressel, 2004; Hays, 2005). In the ELECT-BiLAT project (including the reduction to practice and implementation of the ELECT-BiLAT prototype) these concerns were addressed by developing a system/method based on sound pedagogical principles, creating training scenarios drawing on and validated by the instructors and SMEs, and applying an iterative development process with frequent interaction between instructor/SMEs and the training system developers.

As part of the goal to create a rapid development framework, work is being done to make in-game content and functions authorable. These tools are being targeted at a number of different users. One user may be an instructor who could use desktop and web-based tools to manipulate and generate content without the support of a programmer. Another user may be a training developer who will build and maintain the applications. And, some of the tools and methods being developed such as the SmartBody animation engine aim to reduce the authoring needs of the content developers.

The development framework used for ELECT BiLAT has already yielded much in the way of defining a deliberate approach for the development of game-based learning applications. The use of training objectives, based on a task analysis of the training domain, as the foundation for developing pedagogically sound training provides implicit validation of game content, promotes relevant tutorial feedback, and acts as the basis for automated assessment. This structure allows game-based training to be developed with clear learning goals and a means to reach those goals. Such training systems will provide future soldiers/students (those in the Army's Future Force) with the skills needed to be successful.

While certain embodiments have been described herein, it will be understood by one skilled in the art that the methods, systems, and apparatus of the present disclosure may be embodied in other specific forms without departing from the spirit thereof.

Accordingly, the embodiments/aspects described herein, and as claimed in the attached claims, are to be considered in all respects as illustrative of the present disclosure and not restrictive.

What is claimed is:

1. A method of teaching conducting bilateral engagement in a cultural context, the method comprising:
conducting preparation for a bilateral engagement, wherein the preparation includes identifying a student's intended outcomes for the bilateral engagement and anticipating the objectives of the bilateral engagement meeting partner, and wherein the preparation includes associating a time cost with each of a plurality of information resources assessed by the student;
conducting a rehearsal of the bilateral engagement;
between the student and a virtual character, conducting a simulation of the bilateral engagement, wherein the simulation includes one or more story-based scenarios, wherein an attitude of the virtual character is based in part on a level of trust that has been generated by earlier actions and conversations between the student and the virtual character;
conducting after-action review of the simulation;
providing the student with a game-based graphical environment, wherein the graphical environment comprises (i) an Experience Manager configured and arranged to support preparation for the bilateral engagement, (ii) a Dialogue Manager that is configured and arranged to generate spoken responses for the virtual character, (iii) a software module for automatically and dynamically generating non-verbal behavior of the virtual character based on a given utterance, and (iv) a social simulation module configured and arranged to determine negotiation decisions for business terms, and (v) an intelligent tutoring system including a coach, a reflective tutor, and/or an expert model; and
providing the student with a user interface for interacting with the graphical environment.
